(19) United States
(12) Patent Application Publication
(10) Pub. No.: US 2012/0191594 A1
(43) Pub. Date: Jul. 26, 2012

(54) ONLINE BUSINESS METHOD FOR PROVIDING A FINANCIAL SERVICE OR PRODUCT

(75) Inventors: Bradley Welch, Fort Mill, SC (US); Derek VanHoose, Fort Mill, SC (US)

(73) Assignee: Social Avail LLC.

(21) Appl. No.: 13/166,934

(22) Filed: Jun. 23, 2011

Related U.S. Application Data
(60) Provisional application No. 61/434,474, filed on Jan. 20, 2011.

(51) Int. Cl. G06Q 40/00

(52) U.S. Cl. 705/38; 705/35

(57) ABSTRACT

An online business method for providing a financial service or product, like an installment loan, generally includes the steps of: authenticating the identity information of an end/user applicant via online information and assigning a risk score; originating and servicing the loan through a platform that integrates ancillary products; disclosing expenses and fees via an interactive loan disclosure meter; and providing an option for automatic repayment within the loan signing process.

### RELATED APPLICATION

This application claims the benefit of co-pending provisional application Ser. No. 61/434,474 filed Jan. 20, 2011.

### FIELD OF THE INVENTION

The instant invention relates to online business methods, and more particularly to an online business method that may be utilized for providing a financial service or product.

### BACKGROUND OF THE INVENTION

Financial services and products refer to services and products provided by the finance industry. The finance industry encompasses a broad range of organizations that deal with the management of money. Among these organizations are credit unions, banks, credit card companies, insurance companies, consumer finance companies, stock brokerages, investment funds and some government sponsored enterprises. Financial services and banks typically include some form of transaction where trust is essential. One type of financial service or product is an installment loan. Although the instant invention uses an installment loan as an example of a financial service or product, the invention is not so limited, and may be directed to any other financial services or products.

An installment loan is a loan that is repaid over time with a set number of scheduled payments. The term of loan may be as little as a few months and as long as 30 years. A mortgage, for example, is a type of installment loan. However, the term is most strongly associated with traditional consumer loans, originated and serviced locally, and repaid over time by regular payments of principal and interest. These “installment loans” are generally considered to be safe and affordable alternatives to payday and title loans, and to open ended credit such as credit cards.

Installment loans are clearly an example of a financial service or product where trust in the borrower is essential. As such, one of the first steps in providing an installment loan to a borrower is to authenticate the person's identity. A financial service company has a legal obligation to verify the identification (hereinafter may be referred to as “ID”) of named loan applicants. Whether the customer's identifying information is submitted online or in a branch office, modern day technology makes it easier for a malicious person or organized crime ring to alter traditional proofs of identification, i.e., government issued IDs and pay stubs. In addition, due to modern technology and societies use of the internet, consumers demands/expectations are to receive “instant gratification” or real-time or near real time decisions whether it be in a financial companies branch or on the companies website. However, a solid verification process is essential to mitigate loan fraud and to ensure loan performance, especially in the on-line environment. Typically, authentication is done by manually researching the identification information of the borrower (or other participants in financial transactions where trust is essential). However, this process is very tedious, is not “instant”, can lead to human errors and inconsistencies, and is less reliable when taking installment loan requests on-line. Thus, there is a need for an authentication process that is quicker, provides “instant” results, requires less manual labor, is reliable, and/or can be used when taking an installment loan request on-line.

Another step in providing an installment loan is the loan origination and servicing. Loan origination is the process by which a borrower applies for a new loan, and a lender processes that application. Origination generally includes all the steps from taking a loan application through disbursal of funds (or declining the request). Loan servicing generally covers everything after disbursing the funds until the loan is fully paid off. Loan origination is a specialized version of new account opening for financial services organizations. Certain people and organizations specialize in loan origination, like student lenders, credit card companies, auto loan companies, etc, with mortgage brokers and other mortgage originator companies serving as a prominent example. One of the functions performed during installment loan origination and servicing is the offering of ancillary products, like insurance, auto clubs, credit life, credit displacement, credit property, involuntary unemployment, debt cancelation, product warranty, etc. Installment lenders typically use the same ancillary product companies. However, lenders typically do not have the technology and resources to easily integrate and manage ancillary products into an online fulfillment process. Thus, there is a need for a process or software solution of loan origination and servicing that integrates the ancillary product companies into the online installment loan process.

Another step in providing an installment loan is the disclosure of the loan expenses and fees. Loan companies are facing greater scrutiny to adequately disclose expenses and fees associated with loan transactions. While the installment loan product offers many built in disciplines to the benefit of the borrower, in comparison to other short term loans (i.e. pay day loans), many advocates are still critical of how installment lenders handle the sell of ancillary products and disclose fees and expenses associated with the loan transaction, both inside and outside of the annual percentage rate (APR). Typically, lenders disclose the expenses and fees in a standard contract with a summary required by the Truth in Lending Act (hereinafter may be referred to as “TILA”). This contract with the summary of fees and expenses is typically a long, small font, legal document that is very difficult for most applicants to read and comprehend. This leads to most applicants signing the document without even understanding and/or reading the explanation of the expenses and fees. In addition, these contracts are standard and do not allow for customization. Thus, there is a need for a process for disclosing the loan expenses and fees that is easier for an applicant to read and comprehend and allows the applicant to customize the loan, while still meeting the requirements of TILA.

Yet another step in providing an installment loan is the process of providing an applicant the option of opting into forms of repayment. Repayment can be done in many ways, including, cash, check, electronic bank draft or electronic funds transfer (EFT), on-line bill pay, allotment (for example, “Military allotment”), payroll deduction, etc. The most secure forms of repayment are automatic repayments, like EFTs, on-line bill pay, allotments, and payroll deductions. These automatic payments benefit both the customer and the company in regards to the ease and consistency of loan repayment. However, lenders cannot force a customer to repay their loan by an automatic transfer. In addition, the process of setting up an automatic transfer is typically done by the applicant filling out a form and mailing it in. Thus, there is a need for a process of providing a borrower the option of opting into automatic forms of repayment during the loan request process that can be done on-line.

The instant invention of an online business method for providing a financial service or product is designed to address the above mentioned problems.

### SUMMARY OF THE INVENTION

The instant invention is directed toward an online business method for providing a financial service or product. For example, the instant invention may be directed toward a process of providing an installment loan. However, the invention is not limited to typical consumer loans associated with the term installment loan and may be utilized in other various business methods, like, mortgages, credit, other financial services or products, and any other non financial services where trust is essential. Thus, although the instant invention will be described in detail for the embodiment of providing an installment loan, other embodiments of providing financial services or products where trust is essential is contemplated by the instant invention and should be understood by one skilled in the art. Therefore, as should be understood by one skilled in the art, the present invention may be embodied in other forms without departing from the spirit and the essential attributes thereof, and, accordingly, reference should be made to the appended claims, rather than to the specification, as indicated in the scope of the invention.

The online business method for providing a financial service or product may generally include the steps of: authenticating the identity information of a borrower via online information; originating and servicing the loan through a platform that integrates ancillary products; disclosing “Truth in Lending” expenses and fees via an interactive loan disclosure meter; and providing an option for automatic repayment within the loan signing process.

The step of authenticating the identity information of an applicant/end user via online information and assigning a risk score may be done in any form including providing any steps for authenticating the identity information of a borrower online. This step of authenticating the identity information of an applicant/end user via online information and assigning a risk score may take online information and transform it into a risk score. In addition, the online step of authenticating the identity information of an applicant via online information may include providing an online request form with a section adapted to allow the applicant to opt into sharing private online information with the lender during the request process. The online information may be any public information, including, but not limited to, being public and non-public or private shared information. The online information may be any online public or private information (once opted into by the applicant) including: open source information; private social space information; online application information; and combinations thereof. The social space information may include any social space information, including, but not limited to, Facebook®, Myspace®, Twitter®, Foursquare®, dating sites, Picassa®, Pandora®, Last.fm®, Linkedin®, etc. The online application information may include information gathered by an application developed and/or managed by the lender. As an illustrative example, the lender may develop an online social network application similar to Farmville® that may be loaded onto Facebook® or other social sites and then utilized to gather identity information of users. In one embodiment, the step of authenticating the identity information of a borrower via online information may be an automated process. This automated process may be done via web crawlers adapted to scan the online public and private information or through an “instant” query/transmission of profile data by the end-user opting into installing/downloading the financial company's social network application. The web crawlers may gather public information and APIs used to collect and store private social space information shared by the applicant. In one embodiment, the automated process may include a risk scoring algorithm based on key data points stored in a local database which may be gathered by the web crawlers and/or online application. The key data points collected through the web crawlers or online application may trace the public web and private shared social space and may correlate against information provided by the borrower via fields completed in the online request form and found in their credit bureau file. Such sections of the online request form (i.e. loan application) that are compared to the online information may include, but are not limited to: personal contact, SSN, residential history, employment information, financial information, online posts, profile pictures, interests, location “check in” history, wall, etc. The risk scoring algorithm may calculate a risk score for the applicant based on information providing by the borrower in the online request form compared to the key data points. In one embodiment of the risk scoring algorithm, the algorithm may move a request form to an auto approval queue/status when the risk score may be below a threshold, and the risk scoring algorithm may move a request form to various levels of manual verification/authentication or auto turn the request form down when the risk score being above the threshold. After the loan is processed and the repayment period begins, the lender or company may then conduct on-going marketing and risk mitigation using the same authentication process. This ongoing step may include the continued utilization of the web crawlers and/or the online social media application developed and/or managed by the lender or company in order to provide on-going marketing and risk mitigation, including, but not limited to, on-going customer service, on-going marketing, and getting on-going alerts to a security dashboard.

Automated online borrower identification and risk scoring algorithms may be built-on open source information, private social space information, and online request form information. Open source may be discovered by the company employing web crawlers and private source information provided by the borrower opting into sharing profile information with the company during the request form process. Key data points may be stored in a database, which may be a database that is local to the company, lender, or technology vendor, i.e., Social Avail, LLC. The key data points may then be correlated against the information provided by the borrower in the online request form and other known borrower information. The correlation process may then automatically assign a risk score to the borrower. The higher the risk score the more additional verification steps may be required. The lower the risk score the quicker the request form can be processed, including auto approving the borrower. Basically this may be a “threshold based analysis” where below the threshold the application is expedited through the pipeline but after the threshold is met analyst/associate eyes are put on target and additional verification stipulations are required before the request form is processed.

The step of originating and servicing the loan through a platform that integrates ancillary products may be done in any form and may include any steps for providing the platform online. Providing an online platform may allow an applicant to access the platform directly online, or, in the case of a traditional application where an applicant visits a lenders branch, an employee of the lender may access the platform online and take the application over the counter. The ancillary products may be any ancillary products, including, but not limited to: insurance, auto clubs, credit life, credit displacement, credit property, involuntary unemployment, debt cancelation, product warranty, and combinations thereof. The step of originating and servicing the loan through a platform that integrates ancillary products may include providing an online program being a software with browser based capabilities that includes all ancillary products built into the program. The program may include ancillary products documents/contract, rates, state specific compliance rules, etc. The online program may be hosted by the provider of ancillary products, like an ancillary product broker or originator/ancillary product company, or the online program may be installed on the lenders servers. In one embodiment, the online program may be customizable with various web templates, customer loan applications, and customer portals, thereby allowing the online program to be customized to fit the individual corporate brand for various lenders. In another embodiment, the online program may be adapted to allow a lender to select from a list of ancillary products offered, whereby the online program calculates the cost to the borrower based on an interest rate type, a product cost, and/or state regulations. In yet another embodiment, the online program may be adapted to allow ancillary product document creation and mapping and design.

The step of disclosing “Truth in Lending” expenses and fees via an interactive loan disclosure meter may be done in any form and may include any steps for disclosing such expenses and fees online. The interactive loan disclosure meter may be provided to all approved applicants. The interactive loan disclosure meter may have any shape, including, but not limited to, the shape of a vertical or horizontal charity fundraiser goal meter. In one embodiment, the interactive loan disclosure meter may include color coded fees and expenses. These color coded fees and expenses may be linked or mapped to the Truth & Lending Summary of the application. In another embodiment, the interactive loan disclosure meter may be adapted to allow the applicant to select different sections of the meter where descriptions of that section appear along side the meter. The applicant can then be prompted to remove the expense if it is associated with an optional product/service, like the ancillary products discussed above. In yet another embodiment, the interactive loan disclosure meter may include a slide ruler adapted to allow an applicant to slide the meter to build a shorter term to pay the loan off early or a longer term to enjoy lower monthly benefits. The slide ruler feature may be provided within a range already defined by the lender. In this embodiment, if the applicant slides the slide ruler to a shorter term, then experiences an emergency and needs a lower monthly payment, the interactive loan disclosure meter may be adapted to allow the borrower to exercise the right to automatically modify their loan to the option they did not select. The option to modify the borrower's loan may be facilitated by a single click loan modification feature in an online account. The single click may auto recalculate the loan, generate the loan contracts and sign them.

The step of providing an option for automatic repayment within the loan signing may be done in any form and may include any steps for providing the option for automatic repayment online. The step of providing an option for automatic repayment within the loan request form may include an online loan acceptance program. The online loan acceptance program may be adapted to allow the applicant to opt into voluntary repayment plans. The voluntary repayment plans may be any repayment plans, including, but not limited to: payroll deduction; online bill pay through the applicant's bank; a standard schedule bank draft outlined only by the loan contract; and combinations thereof. The payroll deduction option may be provided only if the applicant works for a company that is integrated with the lenders payroll deduction system or if the payroll company is integrated with the lenders system. The online bill pay through the applicant's bank option may include an auto-enrollment of the borrower in their bank's online bill pay system in their checking account, savings account, or a separate bank account created for the installment loan. Setting up an automated voluntary repayment plan at loan signing may greatly improve performance, regardless of its voluntary nature.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a flow chart of one embodiment of the online business method for providing installment loans according to the instant invention.

FIG. 2 is a flow chart of one embodiment of a method of authenticating the identity information of an applicant via online information according to the instant invention.

FIG. 3 is a website wireframe diagram of one embodiment of the management console used for the method of authenticating the identity information of an applicant via online information shown in FIG. 2.

FIG. 4 is a website wireframe diagram of one embodiment of the automated process for the method of authenticating the identity information of an applicant via online information shown in FIG. 2.

FIG. 5 is a website wireframe diagram of one embodiment of the risk scoring algorithm for the method of authenticating the identity information of an applicant via online information shown in FIG. 2.

FIG. 6 is a website wireflow diagram of one embodiment of the social network application developed and/or managed by the lender or company according to the instant invention.

FIG. 7 is a flow diagram of one embodiment of the method of originating and servicing the loan through a platform that integrates ancillary products according to the instant invention.

FIG. 8 is a flow diagram of one embodiment of the method of disclosing expenses and fees via an interactive loan disclosure meter according to the instant invention.

FIG. 9 is a website wireframe diagram of one embodiment of the interactive loan disclosure meter for the method of disclosing expenses and fees via an interactive loan disclosure meter shown in FIG. 8.

FIG. 10 is a flow diagram of one embodiment of the method of providing an option for automatic repayment within the loan signing process according to the instant invention.

FIG. 11 is a website wireframe diagram of one embodiment of the online loan acceptance program for the method of providing an option for automatic repayment within the loan signing process shown in FIG. 10.

### DETAILED DESCRIPTION OF THE INVENTION

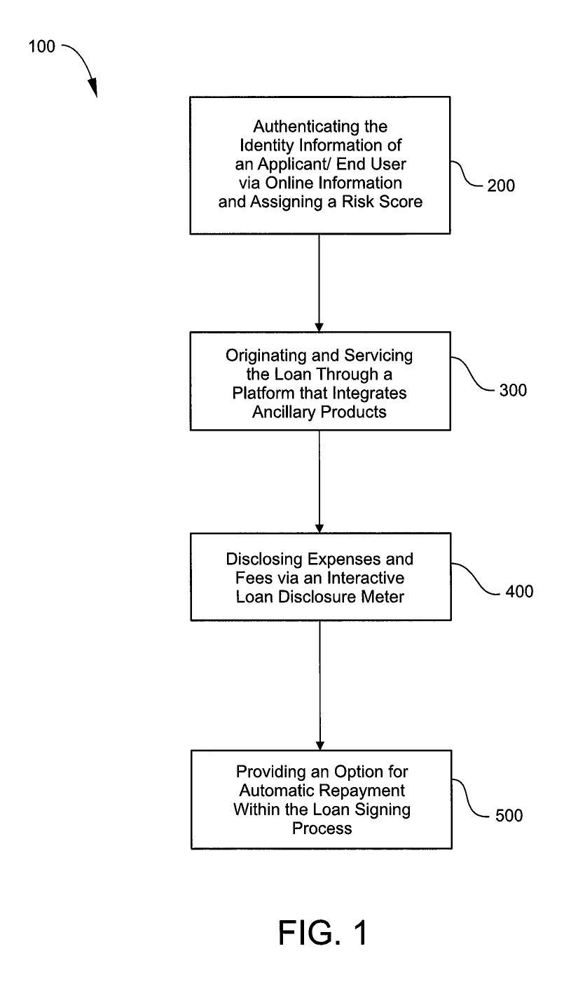

Referring to the drawings, wherein like numerals indicate like elements, there is shown in FIG. 1 an embodiment of an online business method 100 for providing an installment loan. Although this embodiment of instant invention is directed toward an online business method 100 for providing an installment loan, the instant invention is not so limited and may be for providing other financial services or products, or other online transactions where trust is essential. As a result, online business method 100 is not limited to typical consumer loans associated with the term installment loan and may be utilized in other various business methods, like, mortgages, credit, other financial services, and any other non financial services.

The term “online business method” as used herein refers to a business method that may be carried out online. As used herein, “online” refers to the Internet or the World Wide Web. The Internet is a global system of interconnected computer networks that use the standard Internet Protocol Suite (TCP/IP) to serve billions of users worldwide. It is a network of networks that consists of millions of private, public, academic, business, and government networks, of local to global scope, that are linked by a broad array of electronic, wireless and optical networking technologies. The Internet has enabled or accelerated new forms of human interactions through instant messaging, Internet forums, and social networking. Business-to-business and financial services on the Internet affect supply chains across entire industries. A computer network, often simply referred to as a network, is a collection of computers and devices interconnected by communications channels, like the internet, that facilitate communications and allows sharing of resources and information among interconnected devices. Thus, the instant invention of an online business method for providing a financial service or product may be a business method of providing a financial service or product that is conducted over a computer network interconnected by the Internet or World Wide Web.

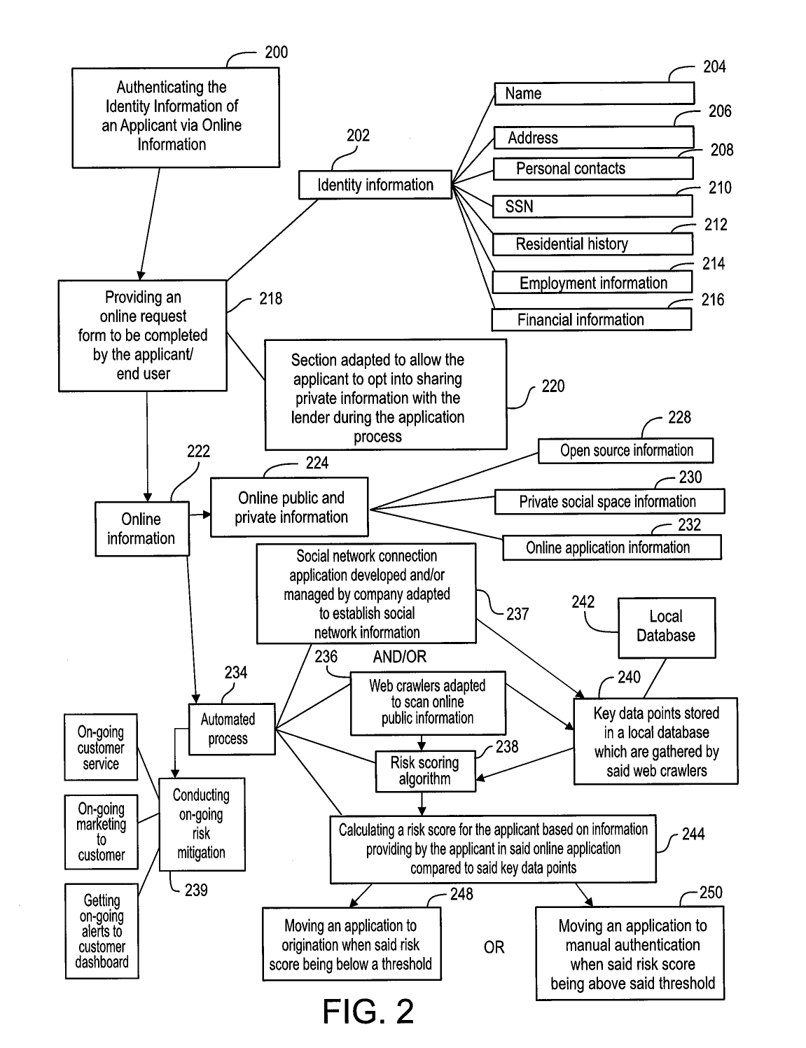

The online business method 100 of providing an installment loan of the instant invention includes at least one of the following four steps: a step 200 of authenticating the identity information of an applicant/end user via online information and assigning a risk score; a step 300 of originating and servicing the financial service or product through a platform that integrates ancillary products; a step 400 of disclosing expenses and fees via an interactive loan disclosure meter; and a step 500 of providing an option for automatic repayment within the loan signing process. The online business method 100 may include one of these four steps or any combination of two or three of the steps, or it may include all four steps, as shown in FIG. 1. These four steps are discussed in detail below as referenced in the embodiments shown in FIGS. 2-10.

Step 200 of authenticating the identity information of an applicant/end user via online information and assigning a risk score may be included in online business method 100 of providing an installment loan. See FIGS. 1-5. However, step 200 is not so limited to typical consumer loans associated with the term installment loan and may be utilized to authenticate the identity information of an applicant/end user via online information and assigning a risk score in other various business methods, like, mortgages, credit, other financial services, and any other non financial services where trust is essential. As such, step 200 may be utilized by other business models outside of the instant online business method of providing a financial service or product like an installment loan. Step 200 of authenticating the identity information of an applicant/end user via online information may be done in any form and may include any steps for authenticating and assigning a risk score online, or over a computer network connected via the Internet. This step of authenticating the identity information of an applicant/end user via online information and assigning a risk score may take online information and transform it into a risk score.

The online step 200 of authenticating the identity information of an applicant via online information may include a step 218 of providing an online request form (may be commonly known as an online loan application). See FIG. 2. Step 218 may include any steps for providing the online request form. The online request form may be any type or form of online request form or application. The online request form may allow the lender to collect the identity information 202 of the applicant/end user. The identity information of the applicant/end user may be any type or form of identifying information, including, but not limited to, a name 204, an address 206, personal contacts 208, a social security number 210 (“SSN”), residential history 212, employment information 214, financial information 216, other identifying information, and combinations thereof.

In one embodiment, the online request form may have a section 220 adapted to allow the applicant to opt into sharing private online information 222 with the lender during the application process. See FIG. 2. The online information 222 may be any online public or private information 224, including, but not limited to, being public and non-public or private shared information. The online information 222 may be any online public or private information (once opted into by applicant) including: open source information 228; private social space information 230; online application information 232; other online private and public information, information gathered by a social network connection application 237 developed and/or managed by the company or lender, and combinations thereof. The social space information 230 may include any social space information, including, but not limited to, Facebook®, Myspace®, Twitter®, Foursquare®, dating sites, Picassa®, Pandora®, Last.fm®, Linkedin®, other social media sites, and any other social space information. The social network connection application 237 information gathered by the company or lender may include information gathered by an social network connection application 237 developed and/or managed by the lender. As an illustrative example, the lender may develop an online social network application 237 similar to Farmville® that may be loaded onto Facebook® or other social sites and then utilized to gather identity information of users.

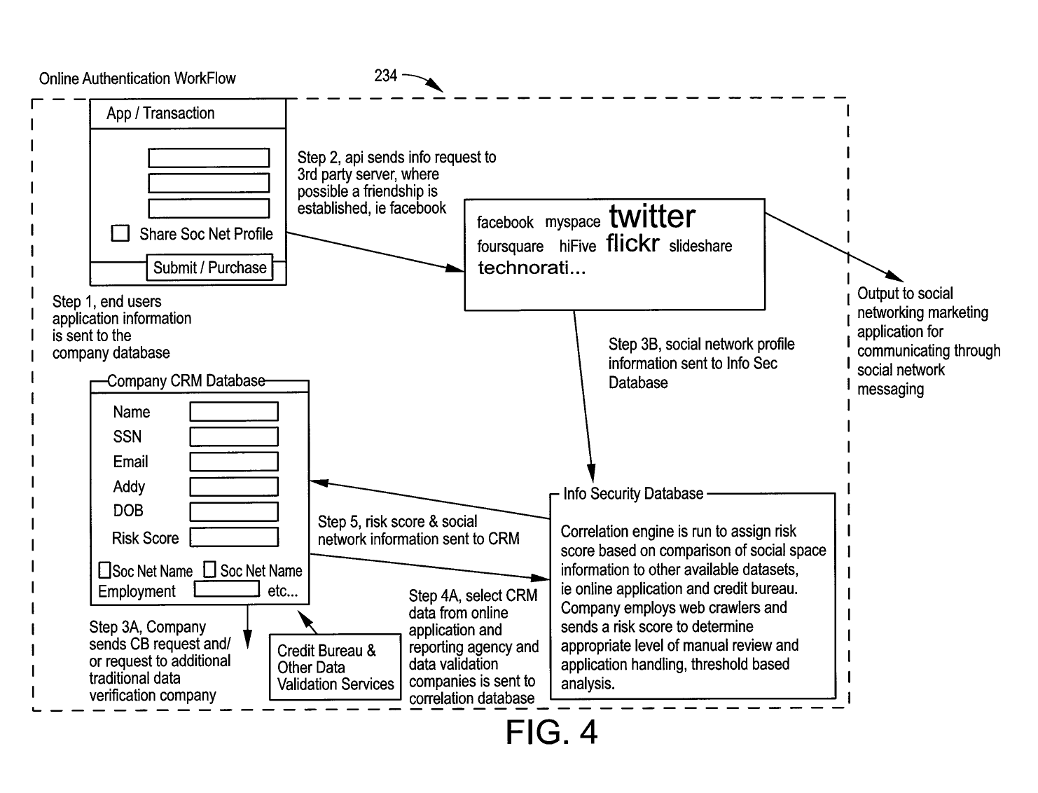

In one embodiment, the step 200 of authenticating the identity information of an applicant via online information and assigning a risk score may be done through an automated process 234. See FIGS. 2 and 4. This automated process 234 may be done via any type or form of authenticated process capable of authenticating identity information of an applicant via online information. In one embodiment, the automated process may include web crawlers 236 adapted to scan the online public and private information. The web crawlers 236 may gather public information and application programming interfaces (“APIs”) used to collect and store private social space information shared by the applicant.

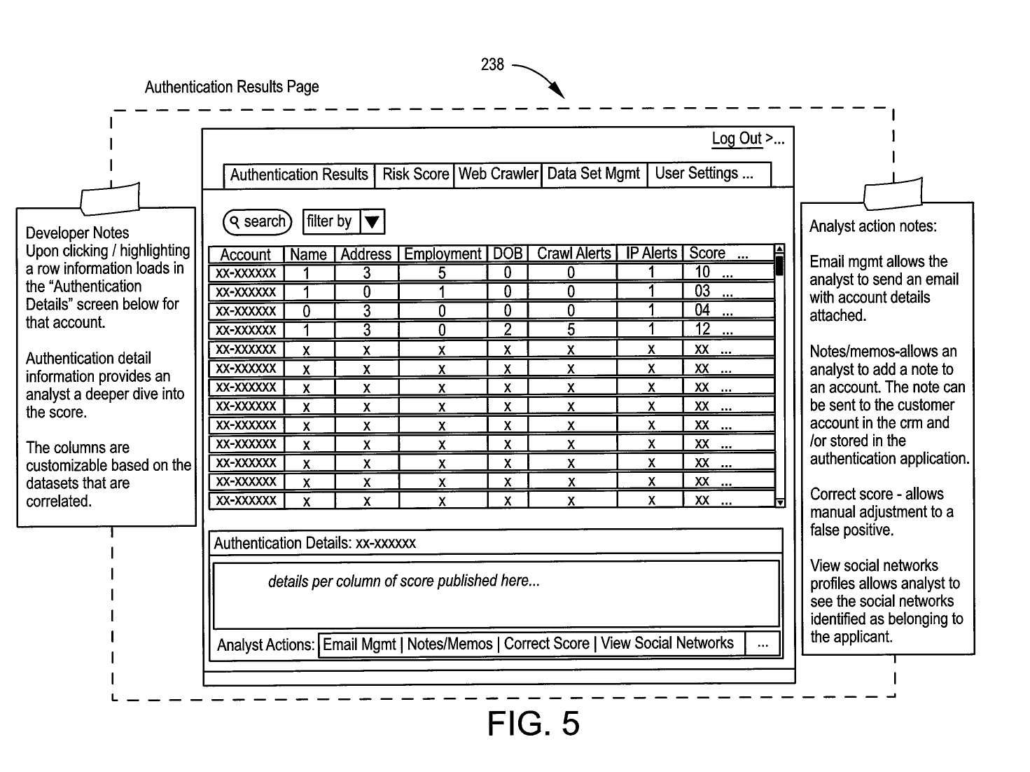

In one embodiment, the automated process 234 may include a risk scoring algorithm 238 based on key data points 240 stored in a local database 242 which may be gathered by the web crawlers 236. See FIGS. 2 and 5. The key data points 240 collected through the web crawlers may trace the public web and private shared social space and may correlate against information provided by applicant via fields completed in the online request form and found in their credit bureau file. Such identifying information sections 202 of the online request form that are compared to the online information may include, but are not limited to: name 204, address 206, personal contacts 208, SSN 210, residential history 212, employment information 214, financial information 216, etc. In addition, other online information may be utilized for obtaining the risk score, like online posts, profile pictures, interests, location “check in” history, wall, etc. The risk scoring algorithm 238 may calculate a risk score (see FIG. 5) for the applicant based on information providing by the applicant in the online application 218 compared to the key data points 240. In one embodiment of the risk scoring algorithm 238, the algorithm may include a step 248 of moving an end/user to origination when the risk score may be below a threshold, or the risk scoring algorithm may include a step 250 of moving an end/user to manual authentication when the risk score being above the threshold. The threshold may be any number assigned by the lender based on the desired risks of the lender.

Automated process 234 for authenticating the identity information of an applicant via online information may be provided in online business method 100 for providing an installment loan (or other business models) to keep overhead cost down and provide the customer a timely loan (or other financial product) decision. Providing online fulfillment is essential to meet the expectations of younger generation of borrowers. Providing a product and service attractive to younger generation positions the company to take full advantage of the customer lifetime borrowing cycle. Automated processes 234 for online end/user identification and risk scoring algorithms 238 may be built-on open source information, private social space information, and online request form information. Open source may be discovered by the company employing web crawlers and private source information provided by the end/user opting into sharing profile information with the company during the request form process via section 220. Key data points 240 may be stored in a local database 242, which may be a database that is local to the company or lender. The key data points 240 may then be correlated against the information provided by the end user in the online request form and other known applicant information. The correlation process may then transform this information and automatically assign a risk score to the application (see FIG. 5). The higher the risk score the more additional verification steps may be required. The lower the risk score the quicker the request form can be processed. Basically this may be a “threshold based analysis” where below the threshold the end/user may be expedited through the pipeline but after the threshold is met analyst/associate eyes are put on target and additional verification stipulations are required before the request form is processed.

Step 239 of conducting on-going marketing and risk mitigation may be included in step 200. Step 239 may take place after the loan has been dispersed or other financial transaction has been completed, i.e., during the payback period of the installment loan or other financial service or transactions. Step 239 may be for providing on-going marketing and risk mitigation for the lender or company. Step 239 may include utilizing the automated process 234 in an on-going basis to providing marketing and risk mitigation. This includes utilizing web crawlers 236 and/or social connection application 237 to provide on-going information gathering throughout the payback period. Step 239 may include any steps for providing on-going marketing and risk mitigation online. In one embodiment, step 239 may include, but is not limited to, providing on-going customer service, providing on-going marketing to the customer, and getting on-going alerts to a security dashboard.

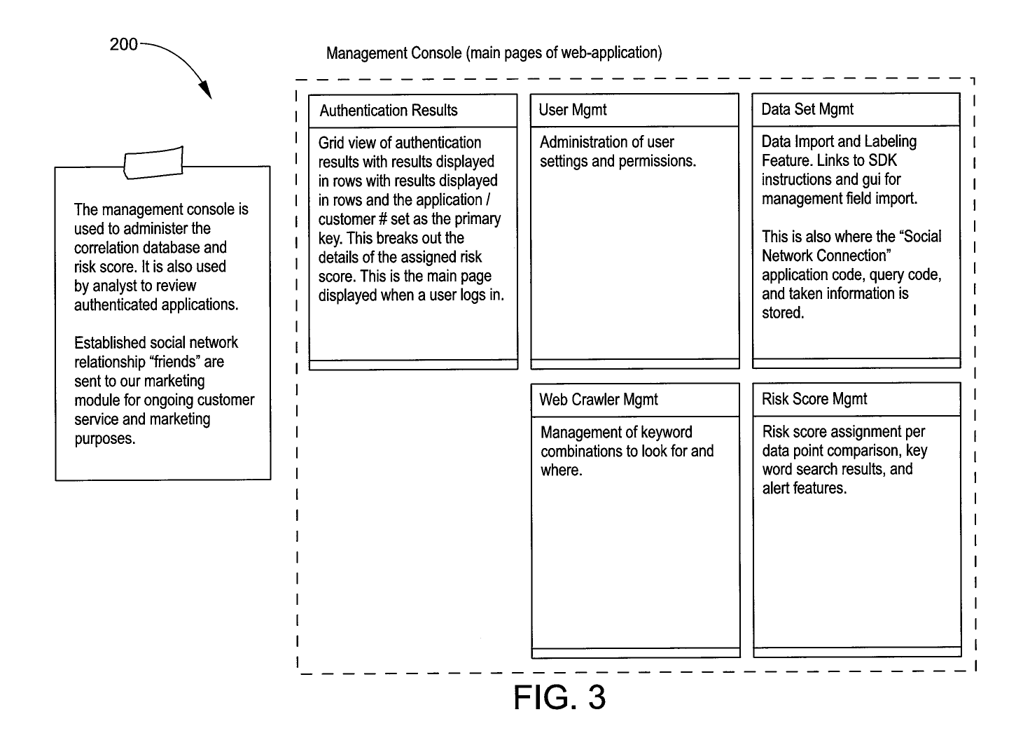

Referring to FIG. 3, a website wireframe of one embodiment of a management console used for step 200 of authenticating the identity information of an applicant via online information is shown. The management console may be used to administer the correlation database and risk score. The management of the analyst dashboard may be done by the lender or a technology vendor, i.e., Social Avail, LLC or combinations of the two. Risk scores can also be passed to company loan software/crm with hyperlinks that expand to provide details of the score. It also may be used by an analyst to review authenticated request forms. In one embodiment, the management console may manage the following: the authentication results, user management, data set management, web crawler management, and risk score management. As an example, with the authentication results, the management console may show a grid view of authentication results displayed in rows with results displayed in rows and the application/customer # set as the primary key. This may break out the details of the assigned risk score. This also may be the main page when a user logs in. As another example, with the user management, the management console may provide administration of user settings and permissions. As yet another example, with data set management, the management console may provide a date import and labeling feature. This feature may link to software development kit (“SDK”) instructions and graphical user interfaces (“GUI”) for management field import. This feature may also be where the social network connection application 237 code, code, query, code, and taken information is stored. As another example, with regard to web crawler management, the management console may provide management of keyword combinations to look for and where. As yet another example, with regard to risk score management, the management console may provide risk score assignment per data point comparison, key word search results, and/or alert features.

Referring to FIG. 4, a website wireframe diagram of one embodiment of the automated process is shown. The process must always begin with providing an online request form to an end/user and having the end/user fill out the identity information and allowing the end/user to opt into sharing information. For example, the customer/end user may opt into the social network application connecting them to the company and allowing the company to query the information below, both instantly, and onging. In the embodiment shown in FIG. 4 of the automated process, an end user's request form information is first sent to the company database, like name, SSN, email, Addy, DOB, Risk Score, location, post, hometown, picture, interest, etc. Next, the request form program interface (“API”) sends info requests to a 3^{rd} party server, where when possible, a connection or friendship is established, i.e. Facebook®. Next, the lender may send a CB request for additional traditional data from a verification company, like credit bureaus and other data validation services. Concurrently, social network profile information may be sent to an information security database. Next, select customer relationship management (“CRM”) data from the online request form and reporting agency and data validation companies may be sent to a correlation database. In the Info security database, a correlation engine may be run to assign a risk score based on comparison of social space information to other available datasets, i.e. online application and credit bureau. The web crawlers may then send a risk score to determine the appropriate level of manual review and application handling with a threshold based analysis. Finally, the risk score and social network information may be sent to the customer relationship management (“CRM”).

Referring to FIG. 5, a website wireframe diagram of one embodiment of the risk scoring algorithm 238 is shown. In this embodiment, an account (i.e. applicant/end user) is given a risk score based on the identifying information provided in the request form compared to the information gathered by the automated process, i.e., name, address, employment, DOB, crawl alerts, IP alerts, etc. This information is then transformed to provide a risk score. All of this information may be displayed in a table where upon clicking/highlighting a row, the information may load in the “Authentication Details” screen below for that account. The authentication detail information may provide an analyst a deeper dive into the risk score. The columns in the table of information may be customizable based on the datasets that are correlated. Within the website interface, the analyst may be provided with many different tabs or options, including, but not limited to: email management, notes/memos, correct score, and/or view social networks. For example, the email management tab may allow the analyst to send an email with account details attached. As another example, the notes/memos tab may allow the analyst to add a note to an account. The note may be sent to the customer account in the customer relationship management (“CRM”) and stored in the authentication application. This note may then be, for example, reviewed by a customer service rep, collector, underwriter, supervisor, etc. This note may also provide the ability to see security analysts notes/emails and to communicate with analyst via a ticket/message system. As another example, the correct score tab may allow for manual adjustment to a false positive. As yet another example, the view social networks tab may allow an analyst to see the social networks and profiles identified as belonging to the applicant.

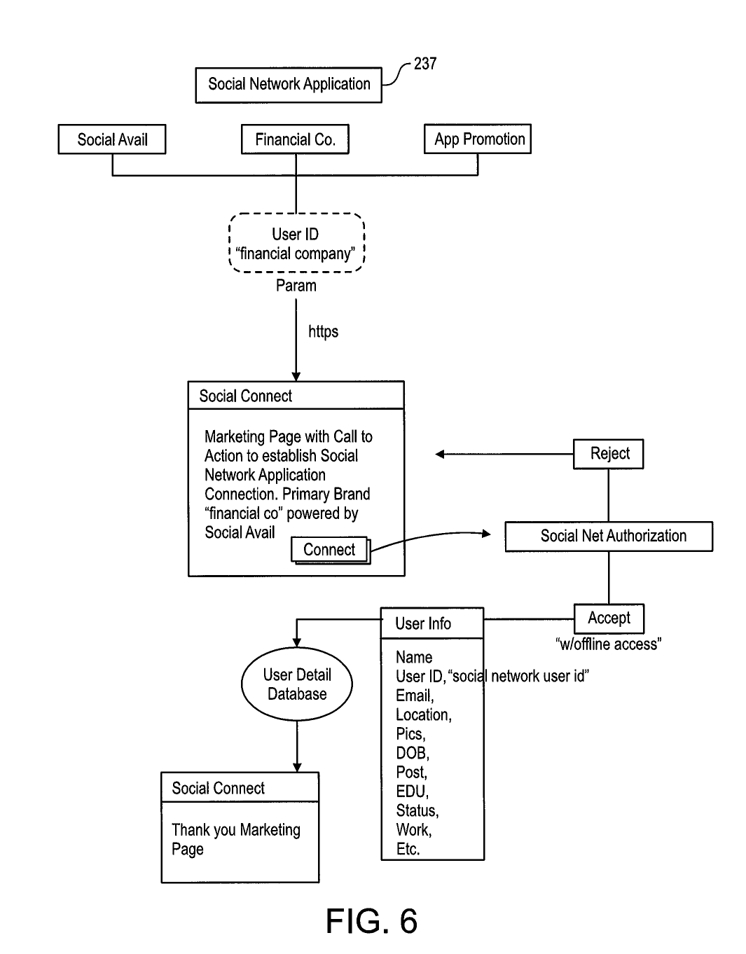

Referring to FIG. 6, one embodiment of a social network application 237 is shown. Social network application 237 may be for facilitating a social network connection with the end/user or borrower. Social network application 237 may be any application for establishing a social network connection. The social network connection application 237 information may be for gathering information of the end/user or borrower. As an illustrative example, the lender may develop an online social network application 237 similar to Farmville® that may be loaded onto Facebook® or other social sites and then utilized to gather identity information of users. The social network application 237 may be developed and/or managed by the financial company or lender, or it may be developed and/or managed by a software lender like Social Avail, LLC, or it may be developed and or managed by an application promotion. Social network application 237 may allow the input of a user ID. From here, a social connect may include a marketing page with a call to action to establish a social network application connection. For example, this may be marketed under the primary brand name of the financial company and powered by Social Avail, LLC. This marketing page may provide a connection tab for social network authorization which may be accepted or rejected by the end/user or applicant. The accepted tab may include offline access. Once accepted, the end/user applicant will be prompted to enter the typical user information, like name, user ID, email, location, pics, DOB, post, EDU, status, work, etc. Once the user information is entered it may be stored in a user detail database. From there a social connect is created and a thank you marketing page may be displayed.

The problems solved by step 200 of authenticating the identity information of an applicant via online information and assigning a risk score may be, but are not limited to, the following: enhanced ability to mitigate identity theft and fraud through automated process; the company can process low risk score request forms more quickly achieving greater customer satisfaction and internal efficiencies; collection and storage of social space and applicant information gives the company the ability to perform ongoing application and customer ring analysis; gives the company the ability to ping social networks to update the information security database on-going (so long as the customer does not opt out of the application connections); the ability to more easily measure viral marketing and current customer relationships; increased penetration of customers opting into non-traditional communication channels where the communication channels are more likely to be maintained by the customer through major life transitions, i.e. customer relocations and cell carrier changes, thus reducing long-term customer service costs; the ability to cross sell/upsell additional products/services; the ability to get alerted of major events/new risk score that might trigger certain action taken by the financial company's customer service department; the ability to maximize existing customer relationships by enjoying more effective and affordable repeat business and lower cost cross-marketing penetration; customer lifestyle/genre categorization, and many others.

One advantage of step 200 of authenticating the identity information of an applicant via online information and assigning a risk score is the opportunity to establish social network relationships, for example, “friends” on Facebook® or an application install. Thus, the management console may utilize the established social network relationship and send it to the lenders marketing module for ongoing customer service and marketing purposes.

Although step 200 of authenticating the identity information of an applicant via online information and assigning a risk score of the instant invention is directed toward installment loans, this step is not so limited. The authentication process of the instant invention may be used to authenticate the identity of an individual for any other process, including, but not limited to, any other online transactions where trust, identification, and speed are desired.

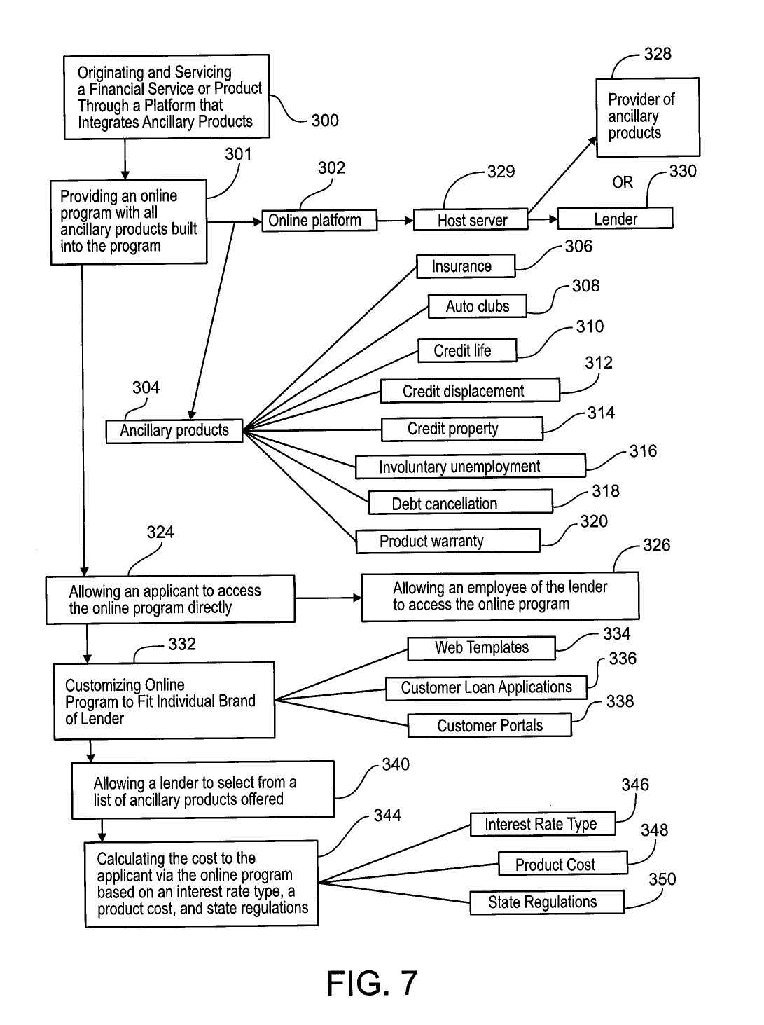

Step 300 of originating and servicing the loan (or other financial product or service) through a platform that integrates ancillary products may be included in online business method 100 of providing an installment loan. See FIGS. 1 and 7. However, step 300 is not so limited to typical consumer loans associated with the term installment loan and may be utilized to originate and service other types of loans and financial services or products in other various business methods, like, mortgages, credit, and any other non financial services. As such, step 300 may be utilized by other business models outside of the instant online business method of providing a financial service or product like an installment loan. The step 300 of originating and servicing the loan through a platform/program that integrates ancillary products may be done in any form and may include any steps for originating and servicing the loan through an online platform or over a network of computers connected via the Internet.

The online step 300 of originating and servicing the loan through a platform/program that integrates ancillary products may include a step 301 of providing an online program/platform with all ancillary products built into the program/platform. See FIG. 7. Step 301 may include any steps for providing online program/platform 302 with ancillary products built into the program/platform. Step 301 of providing such an online platform/program 302 may allow a step 324 of an applicant/end user accessing the platform directly online, or, in the case of a traditional application where an applicant/end user visits a lenders branch, a step 326 of an employee of the lender accessing the platform online and taking the application over the counter.

Ancillary products 304 may be included in step 300 of originating and servicing the loan through a platform that integrates ancillary products. See FIG. 7. The ancillary products 304 may be any ancillary products, including, but not limited to: insurance 306, auto clubs 308, credit life 310, credit displacement 312, credit property 314, involuntary unemployment 316, debt cancelation 318, product warranty 320, other ancillary products, and combinations thereof.

An online program/platform 302 may be included in step 300 of originating and servicing the loan through a platform that integrates ancillary products. See FIG. 7. The online program/platform 302 may be software with browser based capabilities that includes all ancillary products built into the program. The program 302 may include ancillary products documents/contract, rates, state specific compliance rules, etc. The online program 302 may be hosted 329 by the provider of ancillary products 328, like an ancillary product broker or originator/ancillary product company, or the online program may be installed on the lenders servers 330. In one embodiment, the online program 302 may include a step 332 of being customizable with various web templates 334, customer loan request forms 336, and customer portals 338, thereby allowing the online program 302 to be customized to fit the individual corporate brand for various lenders. In another embodiment, the online program 302 may be adapted to provide a step 340 of allowing a lender to select from a list of ancillary products offered, whereby the online program includes a step 344 of calculating the cost to the applicant based on an interest rate type 346, a product cost 348, and/or state regulations 350. In yet another embodiment, the online program may be adapted to allow ancillary product document creation and mapping and design.

Step 400 of disclosing expenses and fees via a Truth in Lending interactive loan disclosure meter may be included in online business method 100 of providing an installment loan. See FIGS. 1 and 8-9. However, step 400 is not so limited to typical consumer loans associated with the term installment loan and may be utilized to disclose the expenses, fees or other contract terms and conditions in other various business methods, like, mortgages, credit, other financial services, and any other non financial services. As such, step 400 may be utilized by other business models outside of the instant online business method of providing an installment loan. The step 400 of disclosing expenses and fees via an interactive loan disclosure meter 402 may be done in any form and may include any steps for disclosing the expenses and fees online or over a computer network connected together via the Internet.

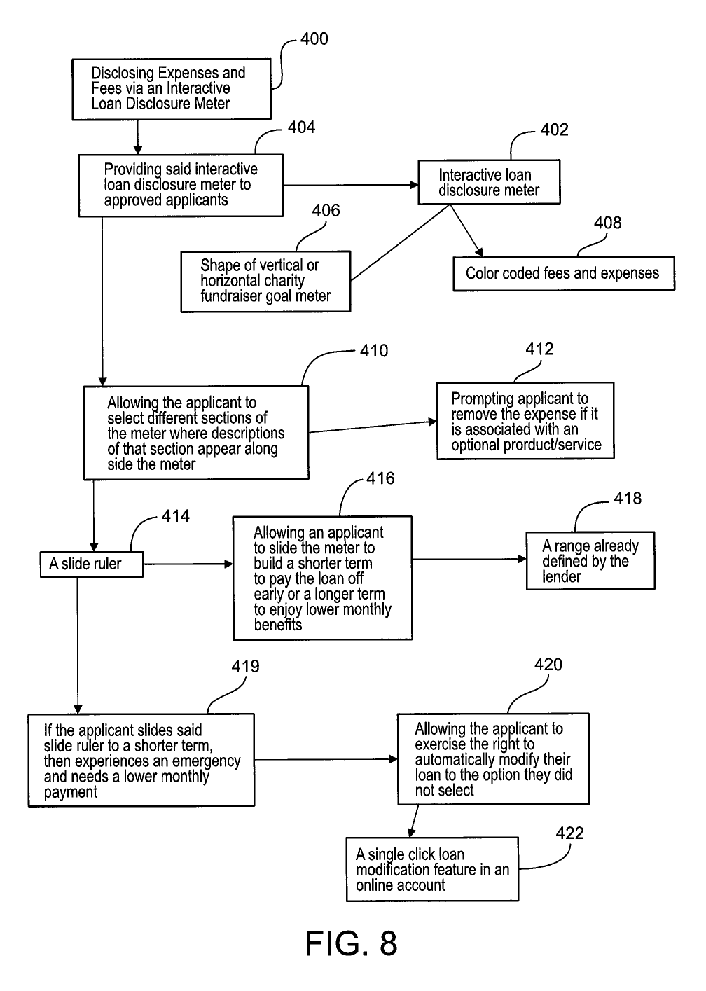

The online step 400 of disclosing expenses and fees via an interactive loan disclosure meter may include a step 404 of providing the interactive loan disclosure meter to approved applicants. See FIG. 8. Step 404 may include any steps for providing interactive loan disclosure meter 402 to approved applicants/end users. The interactive loan disclosure meter 402 may have any shape, including, but not limited to, the shape of a vertical or horizontal charity fundraiser goal meter 406 (see FIG. 8). In one embodiment, the interactive loan disclosure meter may include color coded fees and expenses 408. These color coded fees and expenses may be linked or mapped to the Truth in Lending Act (TILA) Summary of the application.

The Truth in Lending Act (TILA) of 1968 is a United States federal law designed to promote the informed use of consumer credit, by requiring disclosures about its terms and cost to standardize the manner in which costs associated with borrowing are calculated and disclosed. With the exception of certain high-cost mortgage loans, TILA does not regulate the charges that may be imposed for consumer credit. Rather, it requires uniform or standardized disclosure of costs and charges so that consumers can shop. As such, step 400 of disclosing expenses and fees via an interactive loan disclosure meter is designed to meet the standards of TILA and provide consumers with an easy to use interactive display of the expenses and fees of the loan.

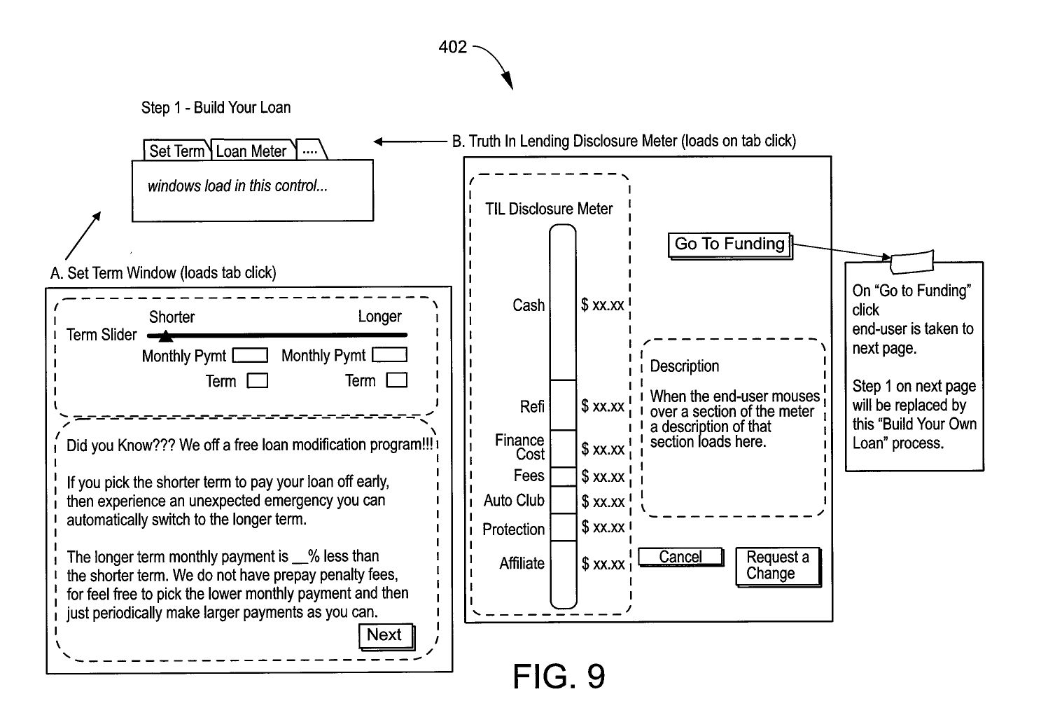

In one embodiment of interactive loan disclosure meter 402, the interactive loan disclosure meter 402 may be adapted to provide a step 410 of allowing the applicant to select different sections of the meter where descriptions of that section appear along side the meter (see FIG. 9). The interactive loan disclosure meter may then allow for a step 412 of prompting the applicant to remove the expense if it is associated with an optional product/service, like the ancillary products discussed above. In yet another embodiment, the interactive loan disclosure meter 402 may include a slide ruler 414 adapted to provide a step 416 of allowing an applicant to slide the meter to build a shorter term to pay the loan off early or a longer term to enjoy lower monthly benefits. The slide ruler 414 feature may be provided within a range 418 already defined by the lender. In this embodiment, if the applicant conducts a step 419 of sliding the slide ruler to a shorter term, then experiences an emergency and needs a lower monthly payment, the interactive loan disclosure meter may be adapted to provide a step 420 of allowing the applicant to exercise the right to automatically modify their loan to the option they did not select. The option to modify the applicant's loan may be facilitated by a single click loan modification feature 422 in an online account. The single click loan modification feature 422 may auto recalculate the loan, generate the loan contracts and sign them.

Referring to FIG. 9, a website wireframe diagram of one embodiment of the interactive loan disclosure meter 402 is shown. In this embodiment, the interactive loan disclosure meter has two sections for allowing the user to build his or her loan: a set term slider or “term slider”; and a Truth in Lending Disclosure Meter. With the term slider, the user can slide the triangle back and forth along the line to shorter and longer terms and the interactive loan disclosure meter will display the monthly payments for the various lengths of terms. A separate section may notify the user of the free loan modification program where, if the user picks a shorter term to pay the loan off early, then experiences an unexpected emergency, the user can automatically switch to the longer term. The user may also be notified that the longer term monthly payment is a certain percentage less than the shorter term and that the lender may not have prepay penalty fees. Thus, the user should feel free to pick the lower monthly payment and then just periodically make larger payments as they can. The Truth in Lending Disclosure Meter may be in the shape of a vertical charity fund raiser meter. The meter may show such expenses and fees as cash, refinance, finance costs, fees, auto club, protection, affiliate, etc. When the end-user may mouse over a section of the meter a description of that section may load in a separate window. The meter may also include a “Go to Funding” tab where the user may be taken to the next page in the application process.

Step 500 of providing an option for automatic repayment within the loan signing process may be included in online business method 100 of providing a financial service or product like an installment loan. See FIGS. 1 and 10-11. However, step 500 is not so limited to typical consumer loans associated with the term installment loan and may be utilized to provide an option for automatic repayment in other various business methods, like, mortgages, credit, other financial services, and any other non financial services. As such, step 500 may be utilized by other business models outside of the instant online business method of providing an installment loan. The step 500 of providing an option for automatic repayment within the loan signing may be done in any form and may include any steps for providing an option for automatic repayment online, or via a computer network linked together via the Internet.

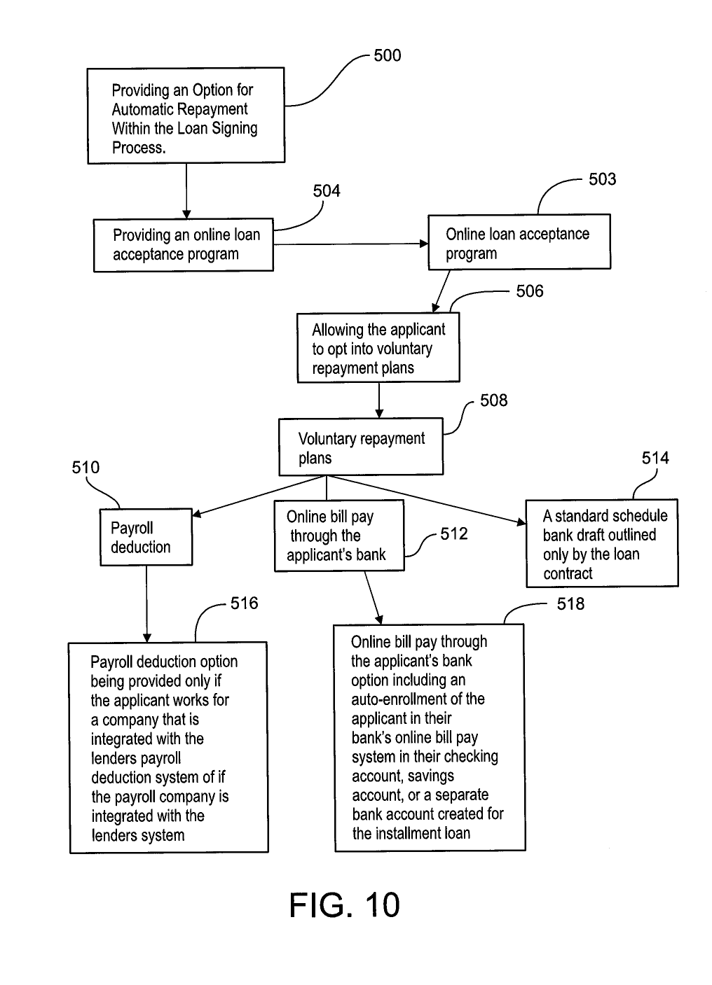

The online step 500 of providing an option for automatic repayment within the loan signing process may include a step 504 of providing an online loan acceptance program. See FIG. 10. Step 504 may include any steps for providing online loan acceptance program 503. The online loan acceptance program 503 may be adapted to provide a step 506 of allowing the applicant to opt into voluntary repayment plans 508. The voluntary repayment plans 508 may be any repayment plans, including, but not limited to: payroll deduction 510; online bill pay 512 through the applicant's bank; a standard schedule bank draft 514 outlined only by the loan contract; other forms of automatic repayment, and combinations thereof. The payroll deduction option 516 may be provided in a step 516 only if the applicant/end user works for a company that is integrated with the lenders payroll deduction system or if the payroll company is integrated with the lenders system. The online bill pay 512 through the applicant's bank option may include a step 518 of auto-enrollment of the applicant in their bank's online bill pay system in their checking account, savings account, or a separate bank account created for the installment loan. Setting up an automated voluntary repayment plan at loan signing may greatly improve performance, regardless of its voluntary nature.

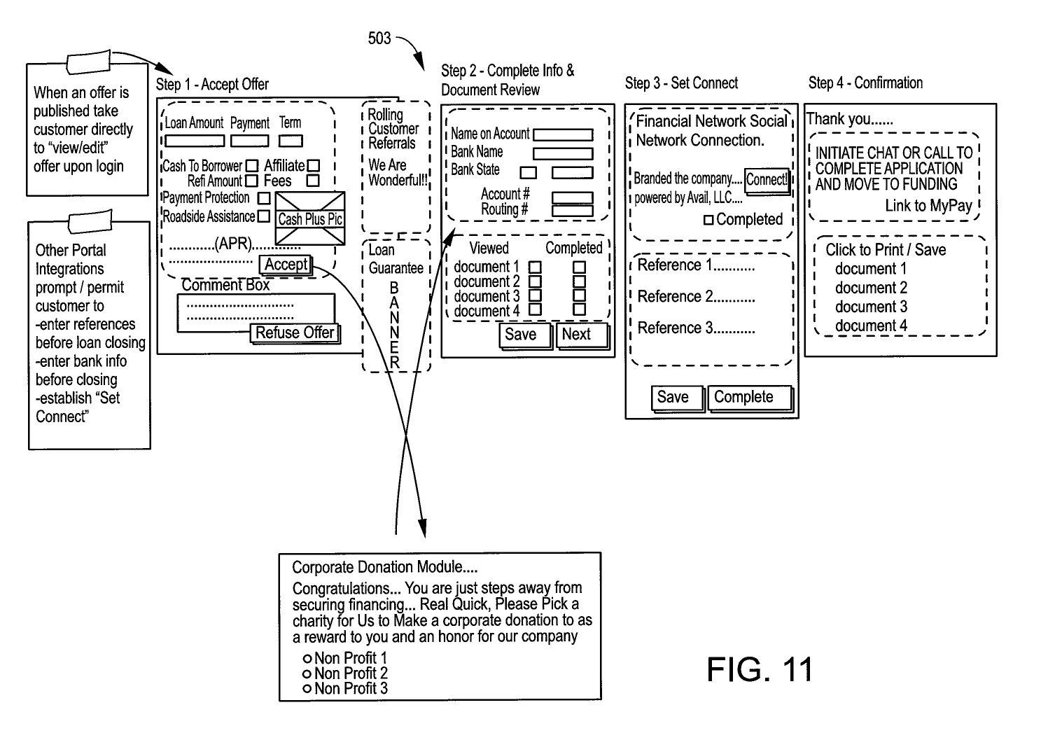

Referring to FIG. 11, a website wireframe diagram is shown for one embodiment of the online loan acceptance program 503. When an offer is published to the applicant, the loan acceptance program 503 may take the customer directly to the “view/edit” offer upon login. Other portal integrations may prompt/permit customers to enter various loan information prior to entering the loan acceptance program, like references before loan closing, enter bank info before closing, establish social network connection developed by Social Avail, LLC on behalf of the financial company, or other various loan information desired by the lender. Once to the loan acceptance program 1, the first step is to accept the offer. In this step, the graphical user interface (“GUI”) will show the customer all of the loan terms, i.e. loan amount, payment, term, cash to borrow, refinance amount, affiliate, fees, payment protection, roadside assistance, annual percentage rate, other loan terms, and various combinations thereof. The GUI may also include a customer referral portion, a loan guarantee banner, or other marketing promotions. The GUI will also include tabs and links for accepting or refusing the offer and a comment box. If the loan terms are accepted, the loan acceptance program moves to the next step of completing the information and document review. Before this next step, the GUI may show other various marketing campaigns. For example, the GUI may show a corporate donation module where the user may select between various non profit organizations for the lender to donate to as a reward to the user. Once to the next step of completing the information and document review, the user may enter in the information needed for automatic repayment, like the name on the account, bank name, bank state, accounting number, routing number, or information needed for other forms of repayment. The bank info may be pulled from existing accounts. The bank account info page may be an Ajax based page that should include supporting text. The GUI may also provide a list of documents with check boxes for whether the documents have been viewed and completed. In this embodiment, when the document is opened the viewed box should be checked, and when the document is signed the completed box should be checked. Once all documents are checked completed, the next step of the loan acceptance program 503 is to set connect. Finally, once through the set connect step, the last step is confirmation. In the confirmation step, the user may be prompted to initiate online chat or call to complete the application and move to funding. In this window, the GUI may provide a link to MyPay® or other various pay sites that may provide funding to the user. In this final step of confirmation, the GUI may also provide links to print and/or save the loan documents. In addition, other various banner and or links may be provided. As examples, language about setting up allotments, language about documents being stored in library, banner about allotments, assistance programs, language about corporate donations, etc. may be shown on the GUI

The present invention may be embodied in other forms without departing from the spirit and the essential attributes thereof, and, accordingly, reference should be made to the appended claims, rather than to the foregoing specification, as indicated in the scope of the invention.

We claim:

1. An online business method for providing a financial service or product comprising the steps of:
authenticating the identity information of an applicant via online information and assigning a risk score; and
disclosing expenses and fees via an interactive Truth in Lending disclosure meter.

2. The online business method for providing a financial service or product of claim 1 wherein said step of authenticating the identity information of an applicant via online information and assigning a risk score including a step of providing an online request form with a section adapted to allow the applicant to opt into sharing private information with the lender during the application process.

3. The online business method for providing a financial service or product of claim 1 wherein said online information being online public and private information being selected from the group consisting of: open source information; private social space information; online application information; and combinations thereof.

4. The online business method for providing a financial service or product of claim 1 wherein said step of authenticating the identity information of an applicant via online information and assigning a risk score being an automated process;
said automated process being web crawlers adapted to scan said online public information;
said automated process including a risk scoring algorithm based on key data points stored in a local database which are gathered by said web crawlers;
said risk scoring algorithm calculating a risk score for the applicant based on the identity information providing by the applicant in said online application compared to said key data points;
said risk scoring algorithm moving an applicant to origination when said risk score being below a threshold; and
said risk scoring algorithm moving an applicant to manual authentication when said risk score being above said threshold.

5. The online business method for providing a financial service or product of claim 4 wherein said risk scoring algorithm including a table listing all of the applicants in the first column and the risk score for the name, address, employment, DOB, crawl alerts, IP alerts, and a total risk score for each of the applicants in the subsequent columns, whereby an analyst may view the details of each applicants risk score by clicking or highlighting the relevant row of said table.

6. The online business method for providing a financial service or product of claim 1 wherein said step of authenticating the identity information of an applicant via online information including a management console;
said management console managing the authentication results, providing user management, providing data set management, providing web crawler management, and risk score management.

7. The online business method for providing a financial service or product of claim 1 wherein said step of disclosing expenses and fees via an interactive loan disclosure meter being done online including the step of providing said interactive loan disclosure meter to approved applicants;
said interactive loan disclosure meter having the shape of a vertical or horizontal charity fundraiser goal meter;
said interactive loan disclosure meter including color coded fees and expenses;
said interactive loan disclosure meter being adapted to allow the applicant to select different sections of the meter where descriptions of that section appear along side the meter, where the applicant can then be prompted to remove the expense if it is associated with an optional product/service;
said interactive loan disclosure meter including a slide ruler adapted to allow an applicant to slide the meter to build a shorter term to pay the loan off early or a longer term to enjoy lower monthly benefits, within a range already defined by the lender;
wherein if the applicant slides said slide ruler to a shorter term, then experiences an emergency and needs a lower monthly payment, said interactive loan disclosure meter being adapted to allow the applicant to exercise the right to automatically modify their loan to the option they did not select;
said option to modify the applicant's loan being facilitated by a single click loan modification feature in an online account.

8. The online business method for providing a financial service or product of claim 1 further including a step of originating and servicing the financial product or service through an online platform that integrates ancillary products.

9. The online business method for providing a financial service or product of claim 8 wherein said step of originating and servicing the loan through an online platform that integrates ancillary products including:
said ancillary products being selected from the group consisting of: insurance, auto clubs, credit life, credit displacement, credit property, involuntary unemployment, debt cancelation, product warranty, and combinations thereof;
said online platform integrating ancillary products including providing an online program with all ancillary products built into the program;
said online platform being adapted for allowing an applicant to access the online program directly, and allowing an employee of the lender to access the online program;
said online program being hosted by the provider of ancillary products or installed on the lenders servers;
said online program being customizable with various web templates, customer loan applications, and customer portals, thereby allowing said online program to be customized to fit the individual corporate brand for various lenders; and
said online program being adapted to allow a lender to select from a list of ancillary products offered, whereby said online program calculates the cost to the applicant based on an interest rate type, a product cost, and state regulations.

10. The online business method for providing a financial service or product of claim 1 further including a step of providing an option for automatic repayment within the loan signing process;
said step of providing an option for automatic repayment within the loan signing including the step of providing an online loan acceptance program;
said online loan acceptance program being adapted to allow the applicant to opt into voluntary repayment plans;
said voluntary repayment plans being selected from the group consisting of: payroll deduction; online bill pay through the applicant's bank; a standard schedule bank draft outlined only by the loan contract; and combinations thereof;
said payroll deduction option being provided only if the applicant works for a company that is integrated with the lenders payroll deduction system or if the payroll company is integrated with the lenders system;
wherein said online bill pay through the applicant's bank option including an auto-enrollment of the applicant in their bank's online bill pay system in their checking account, savings account, or a separate bank account created for the installment loan.

11. An online business method for authenticating the identity of a person and assigning a risk score including:
providing an online request form with a section adapted to allow the applicant to opt into sharing private information during the request form process;
running an automated process being web crawlers adapted to scan said online information;
authenticating the identity information of a person via online information gathered by said automated process; and
assigning a risk score.

12. The online business method for authenticating the identity of a person and assigning a risk score of claim 11 wherein said online information being online public and private information being selected from the group consisting of: open source information; private social space information; online application information; and combinations thereof.

13. The online business method for authenticating the identity of a person and assigning a risk score of claim 11 where said automated process including a risk scoring algorithm based on key data points stored in a local database which are gathered by said web crawlers;
said risk scoring algorithm calculating the risk score for the applicant based on information providing by the applicant in said online request form compared to said key data points;
said risk scoring algorithm moving an applicant to approval when said risk score being below a threshold, and said risk scoring algorithm moving an applicant to manual authentication when said risk score being above said threshold.

14. The online business method for authenticating the identity of a person and assigning a risk score of claim 13 wherein said risk scoring algorithm including a table listing all of the applicants in the first column and the risk score for the name, address, employment, DOB, crawl alerts, IP alerts, and a total risk score for each of the applicants in the subsequent columns, whereby an analyst may view the details of each applicants risk score by clicking or highlighting the relevant row of said table.

15. The online business method for authenticating the identity of a person and assigning a risk score of claim 11 wherein said step of authenticating the identity information of an applicant via online information including a management console;
said management console managing the authentication results, providing user management, providing data set management, providing web crawler management, and risk score management.

16. An online business method for disclosing the expenses and fees of a financial service or product including the steps of:
providing an online request form to applicants of said product;
providing an online interactive disclosure meter to approved applicants of said product;
said interactive disclosure meter being adapted to allow the applicant to select different sections of the meter where descriptions of that section appear along side the meter, where the applicant can then be prompted to remove the expense if it is associated with an optional product/service.

17. The online business method for disclosing the expenses and fees of a financial service or product of claim 16 wherein:
said interactive disclosure meter having the shape of a vertical or horizontal charity fundraiser goal meter;
said interactive disclosure meter including color coded fees and expenses.

18. The online business method for disclosing the expenses and fees of a financial service or product of claim 17 wherein said interactive disclosure meter being adapted for an installment loan and including a slide ruler adapted to allow an applicant to slide the meter to build a shorter term to pay the loan off early or a longer term to enjoy lower monthly benefits, within a range already defined by the lender.

19. The online business method for disclosing the expenses and fees of a financial service or product of claim 17 wherein if the applicant slides said slide ruler to a shorter term, then experiences an emergency and needs a lower monthly payment, said interactive loan disclosure meter being adapted to allow the applicant to exercise the right to automatically modify their loan to the option they did not select.

20. The online business method for disclosing the expenses and fees of a financial service or product of claim 19 wherein said option to modify the applicant's loan being facilitated by a single click loan modification feature in an online account.
